(19) United States
(12) Patent Application Publication
(10) Pub. No.: US 2007/0282893 A1
(43) Pub. Date: Dec. 6, 2007

(54) SYSTEM FOR PROVIDING DIGITAL CONTENT AND ADVERTISING AMONG MULTIPLE ENTITIES

(76) Inventors: Keith Smith, Bellevue, WA (US); Daniel Todd, Bothell, WA (US); York Baur, Issaquah, WA (US); Todd Sawicki, Bellevue, WA (US); William K. McGraw, Seattle, WA (US); Ken Smith, Woodinville, WA (US)

Correspondence Address: PERKINS COIE LLP;PATENT-SEA, P.O. BOX 1247, SEATTLE, WA, 98111-1247, US

(21) Appl. No.: 11/743,103

(22) Filed: May 1, 2007

Related U.S. Application Data
(63) Continuation-in-part of application No. 11/739,663, filed on Apr. 24, 2007.
(60) Provisional application No. 60/794,626, filed on Apr. 24, 2006.
(60) Provisional application No. 60/796,641, filed on May 1, 2006.

(51) Int. Cl. G06F 17/30

(52) U.S. Cl. 707/102; 707/E17.001

(57) ABSTRACT

A system for providing digital content and digital advertisements to users provides digital content via the Internet, in combination with time-shifted advertisements that may be presented by an application that resides on the user's computer. The system may operate in a wholly or partially automated manner, providing automated, self-service interfaces for one or more of the following groups: advertisers, content providers, publishers, and users. The system receives digital advertisement data from advertisers, which can include or consist of a link to an advertiser's website. Advertisers provide compensation based on the presentation of their advertisements to users. The system receives digital content from content providers. Content providers receive compensation when users access digital content provided by content providers. Publishers may access digital content from the system and provide the content to users through one or more user interfaces.

### CROSS-REFERENCE TO RELATED APPLICATION(S)

This application is a continuation-in-part of U.S. patent application Ser. No. 11/739,663, filed Apr. 24, 2007 (attorney docket number 34353-8002.US01), which claims priority to U.S. Provisional Patent Application No. 60/794,626, filed Apr. 24, 2006 (attorney docket number 34353-8002.US00). This application claims the benefit of U.S. Provisional Patent Application No. 60/796,641, filed May 1, 2006 (attorney docket number 34353-8003.US00).

### BACKGROUND

An increasing amount of digital content is available via computer networks, such as the Internet. Digital content may include audio content, video content, audiovisual content, applications, and other content. Digital content may be available to users via a network for a fee, or it may be available free of charge. An increasing number of users are acquiring digital content illegally by not paying the fee due to the content provider for such acquisition.

Digital content may be available via a computer network for a fee, such as through a subscription service, pay-per-acquisition (e.g., pay-per-download) service, or another service. In a typical subscription service, a content provider may receive a fixed amount of compensation for providing its content to the service. The service makes the content available to users and charges the users a fee that is paid for each subscription period (e.g., month, year, or other period). The user may typically access as many content files as the user wishes during the subscription period. In a typical pay-per-acquisition service, a content provider may receive a fixed amount of compensation each time one of the content files it provided to the service is accessed by a user.

Digital content may also be available via a network for free. Content providers may not receive any compensation for the content they provide to users free of charge. This may discourage content providers from providing content to users. If content providers do receive compensation for content that is provided to non-paying users, it is typically a fixed amount.

Digital content may also be available via a network for free when it is distributed in combination with digital advertisements. A network site that offers digital content and digital advertisements will typically display the advertisements at the same time as the content is displayed, or immediately preceding or following display of the content. Advertisements may be displayed in a banner on a network site page, as a pop-up/pop-under window, or in another manner. These advertisements can be distracting to users and can discourage users from taking advantage of free content.

At the same time, many computer network users do not want to pay subscription, per-acquisition, or other fees for digital content. Users may attempt to acquire content for which a fee is due to a content provider without paying the fee due. For example, a first network user may acquire a content file directly from a second network user, such as by copying the content file for free. While the second network user may have legally acquired the content file (e.g., by purchasing the content file), the first user has illegally acquired the content file by not paying the fee due to the content provider.

### BRIEF DESCRIPTION OF THE DRAWINGS

FIG. 1 is a block diagram of a basic and suitable computer that may employ aspects of the invention.

FIG. 2 is a block diagram illustrating a simple, yet suitable system in which aspects of the invention may operate in a networked computer environment.

FIG. 3 is a block diagram illustrating a suitable system in which aspects of the invention may operate in a network environment.

FIG. 4 is a block diagram illustrating a suitable configuration of components of the invention.

FIG. 5 is a flow diagram illustrating a method of providing digital content and advertisements to users, providing compensation to publishers and content providers, and receiving compensation from advertisers.

FIG. 6 is a flow diagram illustrating a method of providing a user with access to content.

FIG. 7 is a block diagram illustrating a user interface through which users may access content.

FIG. 8 is a flow diagram illustrating a method of receiving content from a content provider.

FIG. 9 is a block diagram illustrating a content provider interface through which content providers may upload content.

FIG. 10 is a block diagram illustrating a content provider interface through which content providers may manage uploaded content.

FIG. 11 is a flow diagram illustrating a method of providing content to a publisher.

FIG. 12 is a block diagram illustrating a publisher interface through which publishers may publish content.

FIG. 13 is a flow diagram illustrating a method of receiving one or more advertisements from an advertiser.

FIGS. 14A-14D are block diagrams illustrating advertiser interfaces through which advertisers may provide advertisement data.

FIG. 15 is a flow diagram illustrating a method of adding content and metadata provided by one or more content providers to a media database maintained by the system.

FIG. 16 is a block diagram illustrating a user interface through which users may rate content.

FIGS. 17A and 17B are block diagrams illustrating administrator interfaces through which system administrators can manage accounts of publishers, content providers, advertisers, and users.

Note: The headings provided herein are for convenience and do not necessarily affect the scope or interpretation of the invention.

### DETAILED DESCRIPTION

Overview

A system for providing digital content and advertisements to users is described. In some examples, the system may provide content to users via the Internet, in combination with time-shifted advertisements presented by an application that resides on the user's computer system. The system may operate in a wholly or partially automated manner, providing automated, self-service interfaces for one or more of the following groups: advertisers, content providers, publishers, and users. An automated, self-service advertiser interface may be used by advertisers to provide digital advertisement data to the system. Advertisers may provide compensation to the system when their digital advertisements are presented to users. An automated, self-service content provider interface may be used by providers of digital content to provide content to users. Digital content may be audio content, visual content, audiovisual content, an application, or other content. Content providers may receive compensation when users access the digital content provided by the content provider. An automated, self-service publisher interface may be used by publishers to access digital content and provide that digital content to users. Publishers may provide one or more user interfaces for users to access the digital content. Publishers may receive compensation when users access the digital content published by the publisher. Users may access digital content through user interfaces provided by publishers or one or more user interfaces provided by the system. Further details are provided below.

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description of the various examples.

The terminology used in the description presented below is intended to be interpreted in its broadest reasonable manner, even though it is being used in conjunction with a detailed description of certain specific embodiments of the invention. Certain terms may be emphasized below; however, any terminology intended to be interpreted in any restricted manner will be overtly and specifically defined as such in this Detailed Description section.

Suitable System

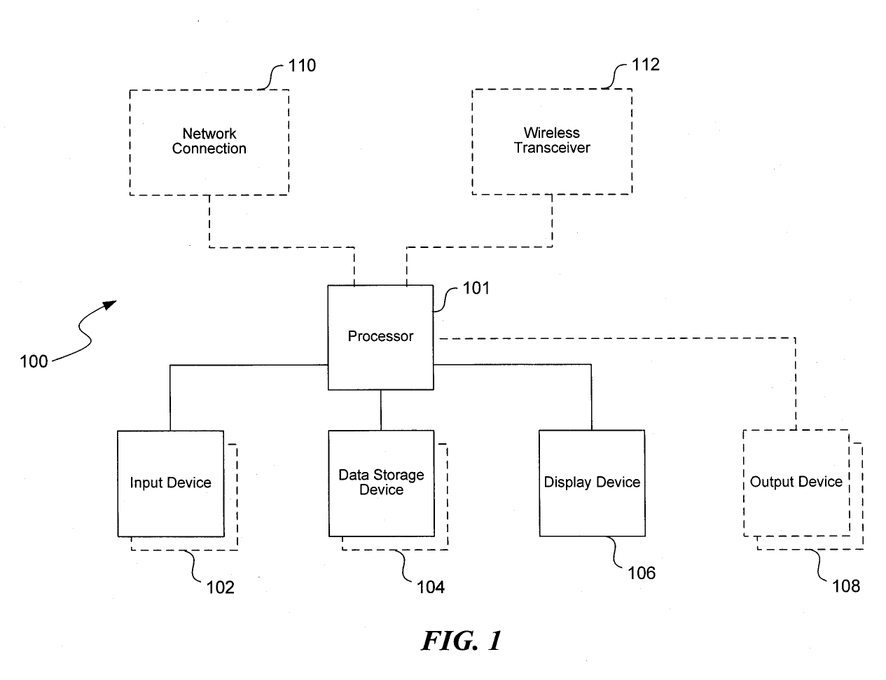

FIG. 1 and the following discussion provide a brief, general description of a suitable computing environment in which aspects of the invention can be implemented. Although not required, aspects and examples or embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

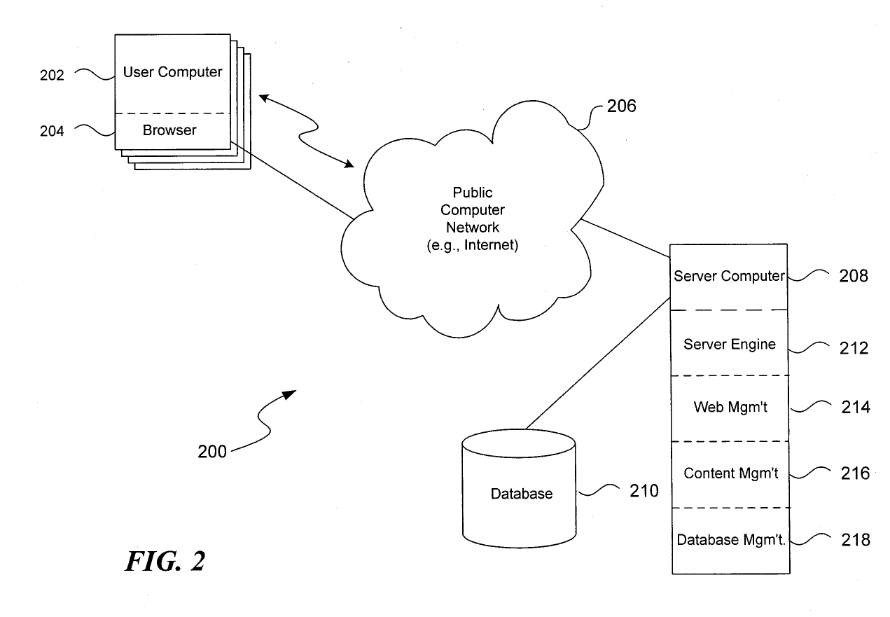

Aspects of the invention may be practiced in a variety of other computing environments. For example, referring to FIG. 2, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, advertisements, bids, keywords, electronic images, etc. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages or screens associated with receiving and providing digital content and digital advertisements. Users may access the server computer by means of a URL associated therewith. The content management component handles most of the functions in the embodiments described herein. The database management component includes storage and retrieval tasks with respect to the database, queries to the database, and storage of data.

Content Economy System

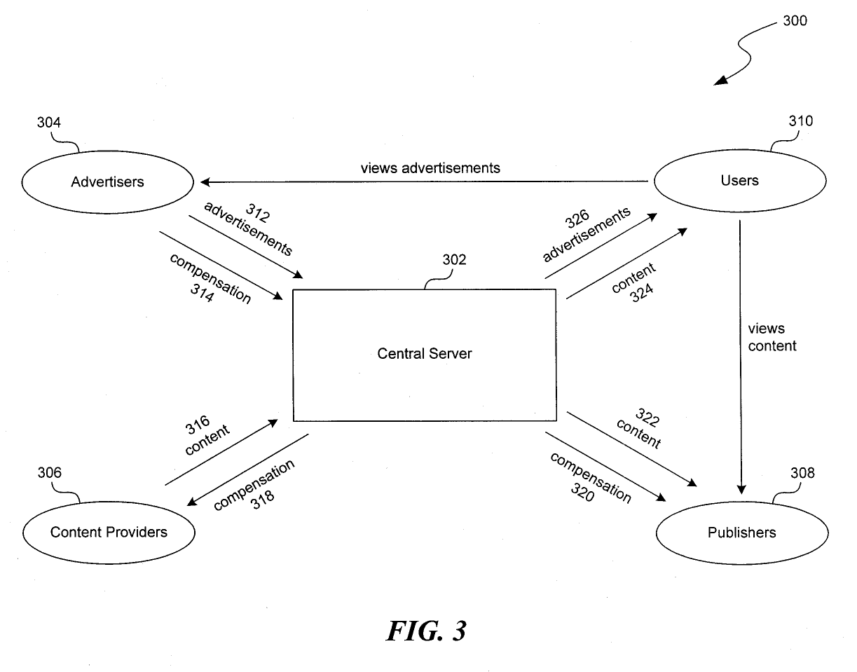

FIG. 3 illustrates one example of the system. At least one central server 302 receives digital advertisement data 312 from advertisers 304. Advertisers 304 provide compensation 314 based on the presentation of their advertisements 326 to users 310. The central server 302 receives digital content 316 from content providers 306. Digital content may be audio content, visual content, audiovisual content, applications, or other content. Content providers 306 receive compensation 318 based on how many users 310 access the digital content 324 provided by the content provider or download a required application in order to access digital content 324 provided by the content provider, or based on other usage data. Publishers 308 publish digital content 322 received from the central server 302. Publishers receive compensation 320 based on how many users 310 access the digital content 324 published by the publisher 308 or download a required application in order to access digital content 324 published by the publisher, or based on other usage data. The system provides user-selected digital content 324 and user-targeted digital advertisements 326 to users 310.

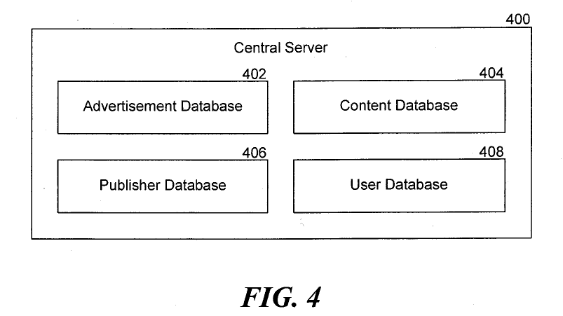

FIG. 4 illustrates an example of components that may comprise the system. A system server 400 may maintain one or more databases, including an advertisement database 402, a content database 404, a publisher database 406, and a user database 408. The advertisement database 402 may contain advertisement data supplied by advertisers, advertisers' account information, and other information. The content database 404 may contain content and/or links to content supplied by content providers, content providers' account information, and other information. The publisher database 406 may contain publishers' account information, configuration information for publishers' content display pages, and other information. The user database 408 may contain users' account information, preferences, and other information.

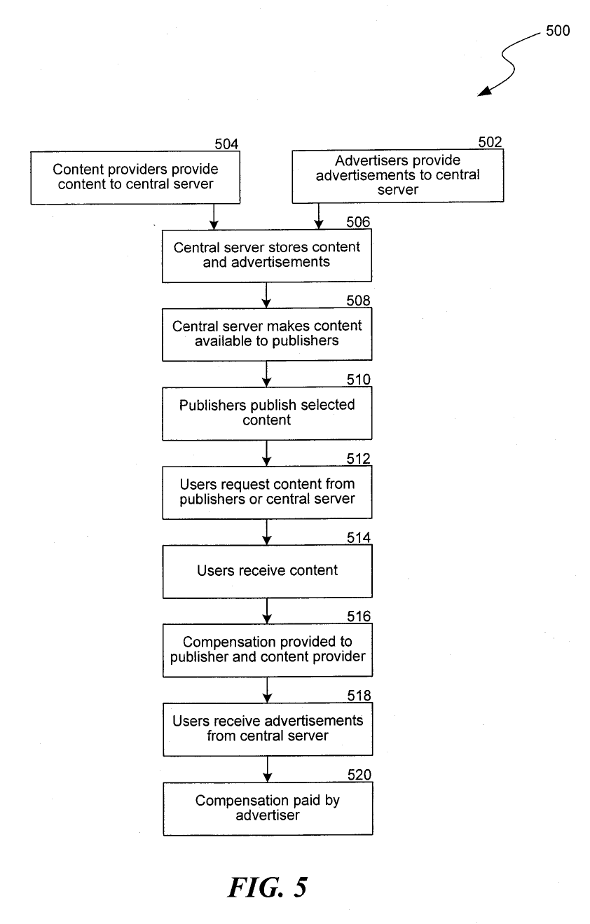

FIG. 5 illustrates a process 500 by which the system may provide digital content and advertisements to users, provide compensation to publishers and content providers, and receive compensation from advertisers. At a block 502 advertisers provide digital advertisement data to the system. An advertisement may be any announcement designed to attract a user's attention, including, but not limited to, a web address to be launched in a browser window by the system. The web address may be an address for an advertiser's web site or web page. Each advertiser may specify one or more targeting criteria, including but not limited to keywords, to be associated with each of its advertisements. A keyword is a word or phrase that may trigger the system to provide the advertisement to a user. In some examples, the system may prohibit an advertiser from purchasing targeting criteria that are not relevant to the products or services offered by the advertiser. In this way, the system may provide relevant, contextual advertisements to users. In addition, each advertiser may specify a bid value associated with each of the specified targeting criteria. A bid value is an amount of compensation that an advertiser is willing to pay for the presentation of its advertisement to a user. Each advertiser may be assigned a unique identifier so that, among other things, the system can determine which advertiser's advertisement to present to a user. Advertisers may also be able to specify the particular content providers and/or publishers, or types of content providers and/or publishers (e.g., based on category or other parameters), with which its advertisements are to be associated.

At a block 504 content providers provide digital content to the system. Digital content may include audio content, video content, audiovisual content, applications, applets, games, or other content or executables. Each content provider may specify one or more keywords, categories, or other parameters to be associated with each of its content files, as explained herein. Each content provider may be assigned a unique identifier so that, among other things, the system can later determine which content was provided to a user.

At a block 506 the system receives and stores the digital content provided by content providers and the digital advertisements provided by advertisers. The system may organize the digital content and digital advertisements by targeting criteria, keywords, categories, or other parameters.

At a block 508 the system makes the digital content available to publishers. A publisher may be any entity that wants to distribute digital content offered by the system. Publishers may search or browse content offered by the system by keyword, category, or other parameters specified by content providers or otherwise associated with the content. A publisher may select particular content files to be included on a content page to be offered by the publisher. Publishers may also request that the system select content files for the publisher. For example, the system may automatically select the most popular content files for inclusion on a publisher's content page. The content files may be linked to or included on a publisher's content page and may be dynamically updated by the system. For example, as the list of most popular content files changes, those content files included on the publisher's content page may be changed to reflect the updated list. Each publisher may be assigned a unique identifier so that, among other things, the system can later determine from which publisher a user accessed content.

At a block 510 publishers publish content provided by the system. A publisher may distribute content through a network site offered by the publisher, through a peer-to-peer network, or in another manner. Publishers may publish content by, for example, including content or links to content on a network site offered by the publisher. The central server may also be a publisher; a publisher is not necessarily a third party that is separate from the central server.

At a block 512 users request digital content from publishers or directly from the system. Users may request content from a publisher by, for example, clicking a link associated with a content file on a network site page offered by the publisher. Digital content may also be made available directly from the system. For example, a user may request content from the system by clicking a link associated with a content file on a network site page offered by the system. A user may discover a particular content file to request by searching one or more databases maintained by the system or a publisher. A user may limit a search to a particular category or may search all categories. Categories may include videos, music, games, and other categories and sub-categories. A user may enter one or more search terms into a text box or other input field, such as on a network site page. The system may search one or more of its databases according to the search terms entered by the user, and display the matching results to the user. If the system does not find any matches, it may display a message to the user that indicates that no matches were found. Alternatively or additionally, a user may discover a particular content file to request by browsing one or more catalogs offered by the system or a publisher, being presented with a promotion display, or in another manner.

At a block 514 the system may provide content to the user. In some examples, a user may be required to have an application installed on the user's computer system prior to receiving digital content and advertisements. The required application may be the Zango Search Assistant, provided by Zango, Inc. of Bellevue, Wash., or a similar client-side application. The required application may allow a user to access digital content and may deliver targeted, time-shifted digital advertisements. As described above, an advertisement may be any announcement designed to attract a user's attention, including, but not limited to, a web address to be launched in a browser window by the system. The origin of browser windows containing advertisements launched by the system may be required to be readily identifiable, such as by a title in the title bar of the browser window, the web address in the address bar of the browser window, or another identifiable manner. Time-shifted advertisements are advertisements that are presented after and often separately from content, such as when a user is later browsing the Internet or conducting an online search after viewing or listening to an item of content obtained from a publisher. For example, when a user enters a URL into a browser or conducts a search, such as by entering search terms at a network search site or into an application installed on the user's computer system, an advertisement may be presented to the user based on the search terms, keywords, or URL entered by the user, or based on another targeting criteria. Time-shifted advertisements may also be presented in one or more ways that do not require the use or installation of a client-side application.

The required application may encourage or compel user permission-based installation, such as via Zango's “Safe and Secure Search” (i.e., “S3”) technology. User permission may be obtained in the form of an End User License Agreement (EULA). The EULA may explain the required application in plain English, so that it is clear to the user what is being installed. These measures may prevent fraudulent installation of the required application without user consent. The required application may be easily uninstalled, such as through the “Add or Remove Programs” process on a Windows-based computer. The required application may also re-notify each user periodically (e.g., every 90 days) to remind the user that the application is installed, what the software does, and how to remove the application if desired. The required application may also be presented in combination with a fraud reporting mechanism, such as Zango's “Closed Loop System” (CLS), which allows users to report incidents of suspected fraudulent installations. The fraud reporting mechanism may provide the system with the information needed to find fraudulent distributors, notify all affected users, and require affected users to re-opt in to keep the application installed.

After users receive content at block 514, at a block 516 compensation is provided to the publisher that published the content and the content provider that provided the content. Compensation may be disbursed to the publisher or content provider once during a given time period (e.g., week or month), may be directly deposited into an account upon a user's access of content, or may be disbursed in another manner. As described above, each publisher and content provider may be assigned a unique identifier so that, among other things, the system can determine which publisher and/or content provider is responsible for distribution of the content to the user. This may aid the system in providing compensation to the appropriate publisher and content provider.

Compensation may be calculated in one or more of a variety of ways. In some examples, a publisher and/or content provider may receive a flat fee for each user that accesses a content file. Alternatively or additionally, if a user is required to have an application installed in order to access content, and the user installs (or re-installs) the required application for the purpose of accessing content from a particular publisher and/or content provider, the publisher and/or content provider may receive a flat fee for such installation. The content provider may receive payment for application installations that are confirmed and/or unconfirmed by the system. Alternatively or additionally, the content provider may receive a payment that varies based on the geographic location (e.g., country) of the user that installed the application.

Alternatively or additionally, a publisher and/or content provider may receive a flat fee for each advertisement delivered to the user, such as $1.00 for each 1000 advertisements.

Alternatively or additionally, a publisher and/or content provider may receive a share of the advertising revenue that is generated by each user that accesses a content file or based on other usage data. In some examples, a content provider may receive a different share of the advertising revenue based on whether it is the content provider's content that enticed the user to use the service offered by the system. For example, if a user installs a required application in order to listen to a song provided by a first content provider, the first content provider may receive a 40% share of the advertising revenue generated by the user. If a user already has the required application installed and chooses to listen to a song provided by a second content provider, the second content provider may receive a 30% share of the advertising revenue generated by the user.

Alternatively or additionally, a publisher and/or content provider may receive a share of the advertising revenue that is generated by each user that accesses content during a particular time period or based on other usage data. In some examples, a content provider may receive a different share of the advertising revenue based on whether it is the content provider's content that enticed the user to use the service offered by the system, as described above. In some examples, the amount of revenue received by a content provider may be based on more than one time period. For example, a content provider may be paid based on whether a user accesses content during a given month, but the content provider may receive payment only for those weeks in which the user accesses content. For instance, a content provider may qualify for payment because a user accessed content in month 1. However, the content provider may only receive its share (e.g., 30% or 40%) of advertising revenue for week 1 of month 1 if the user only accessed content during week 1. This may be referred to as breakage. In some examples, content providers may be guaranteed a minimum amount of compensation per user who accesses during a particular time period. For example, a content provider might be guaranteed $0.06 per user per week or $0.25 per user per month, for all users that access content.

At a block 518 users receive advertisements. In some examples, the system may present advertisements to users via an application that is installed on a user's computer system. In some examples, the advertisements may be time-shifted. That is, an advertisement may not be provided along with the content; instead, the advertisement may be presented separately from the content, such as when a user later browses the Internet or conducts an online search after viewing or listening to an item of content obtained from a publisher. For example, when a user enters a URL into a browser or conducts a search, such as by entering search terms at a network search site or into an application installed on the user's computer system, an advertisement may be presented to the user based on the search terms, keywords, or URL entered by the user. The system may display an advertiser's web site over, beneath, or next to information returned by the user's search. The system may display to the user the advertisement with the highest bid value for the keyword. For example, if advertiser X has bid $0.05 for keyword 1 and advertiser Y has bid $0.03 for keyword 1, the system will display advertiser X's advertisement.

At a block 520 advertisers provide compensation to the system based on the advertisements received by the users at block 518. An advertiser may pay compensation in the amount of the bid value associated with an advertisement when the advertisement is displayed to a user. For example, when advertiser X's advertisement is displayed, it will pay $0.05. While this example indicates that compensation is provided after advertisements are displayed, compensation could be provided by advertisers before their advertisements are displayed. As described above, each advertiser may be assigned a unique identifier so that, among other things, the system can determine which advertisement to present, or was presented, to a user. This may aid the system in determining which advertiser owes compensation for presentation of the advertisement. The system may charge an advertiser the compensation amount, deduct the compensation amount from an account into which the advertiser has previously submitted funds, or obtain payment from an advertiser in another manner.

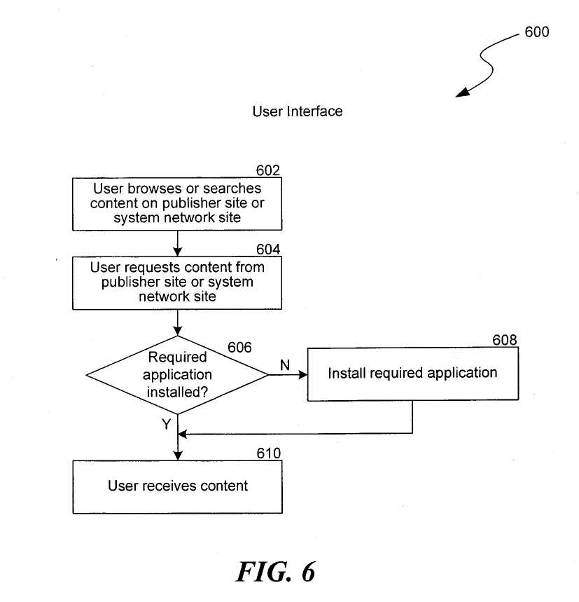

As described above, users may request digital content from publishers or directly from the system. In some cases, a user may be required to have an application installed on the user's computer prior to accessing digital content. FIG. 6 illustrates a process 600 by which a user may receive content from the system, if a user is required to have an application installed. At a block 602 the user browses or searches content on a publisher site or a network site provided by the system. In some examples, a user may search one or more databases maintained by the system or a publisher. A user may enter one or more search terms into a text box or other input field, such as on a network site page. Alternatively or additionally, a user may browse one or more catalogs offered by the system or a publisher, be presented with a promotion display, or may browse or search content in another manner. At a block 604 the user requests content from the publisher site or network site provided by the system. Users may request content by, for example, clicking a link associated with a content file on a network site page offered by the publisher or the system. At a decision block 606 the system determines whether the user has the required application installed on the user's computer system. For example, the system may verify that there is a cookie, certificate, or other identifier present on the user's computer. If the user has the required application installed, at a block 610 the system provides the user with access to the content. If the user does not have the required application installed, at a block 608 the system provides the user with the option to install the required application (or re-install the application if the application has been removed). The user may be required to accept a license agreement in order to install the application. If the user does not accept the license agreement or the application is not successfully installed, the system may restrict the functionality available to the user. For example, the user may be able to access only limited content or access content at a lower fidelity. Once the user has installed the required application, at a block 610 the system provides the user with access to the content.

In some examples, if a user uninstalls a previously-installed required application, the user will no longer be able to receive content or advertisements, unless the application is re-installed. To effectuate this, the system may determine whether or not a required application is installed on the user's computer. If the application is not installed, the system may prompt the user to install or re-install the application before the user can access or view content. If the user installs or re-installs the application, the system will provide content to the user. If the user does not install or re-install the application, the system may restrict the functionality available to the user.

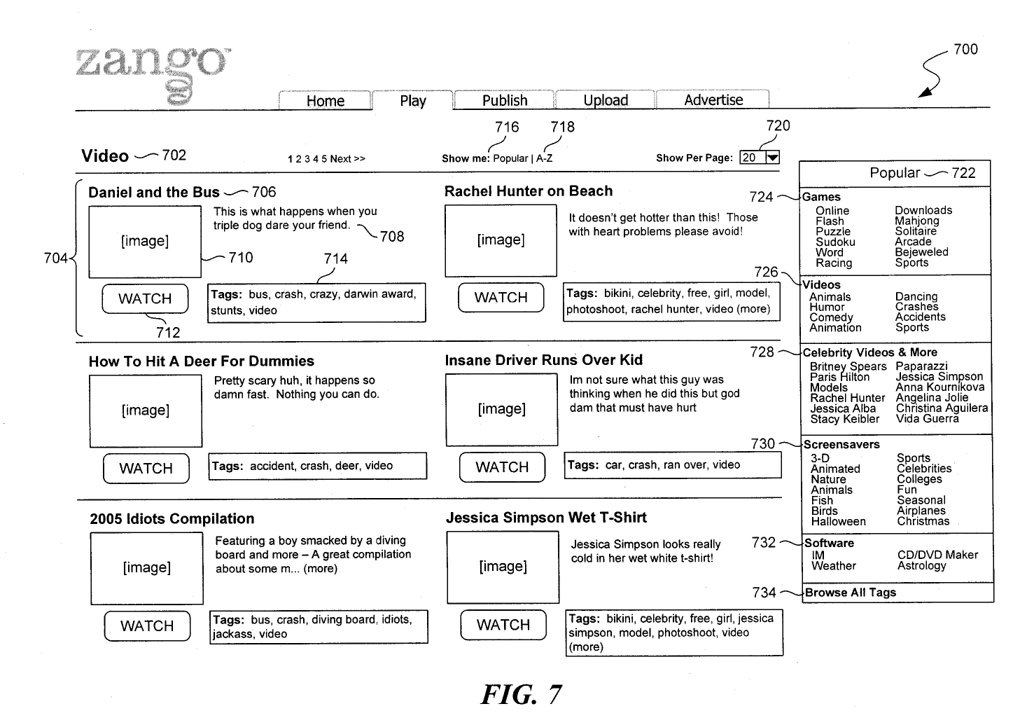

As described above, one or more user interfaces may be provided by a publisher and/or the system. FIG. 7 illustrates a user interface 700 that may be provided by the system. The system may display one or more categories of content to the user, such as Video 702. The system may display one or more content files 704 and information associated with the file. For example, the system may display a title 706, description 708, image 710, link or button 712 to view and/or listen to the content, and tags 714 for each file. This information may be provided by a content provider and/or the system. The user may be able to sort the content to be displayed by popularity 716, alphabetically 718, or other parameters. The user may be able to select 720 how many content files are displayed on each page. The system may display the most popular content 722 and/or one or more categories of content, including, but not limited to, Games 724, Videos 726, Celebrity Videos and More 728, Screensavers, Software, and other categories. Each category may contain one or more sub-categories. In addition, the system may provide the user with an option 734 by which the user can browse all tags associated with available content. One skilled in the art will appreciate that content may be provided by the system to the user in a variety of other ways, including through other user interfaces.

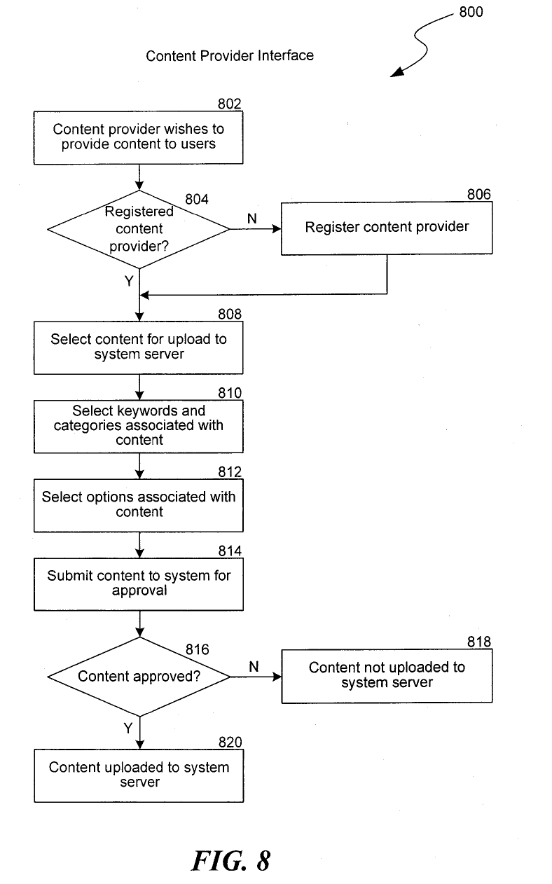

The system may provide an automated, self-service content provider interface that may be used by providers of digital content. The content provider interface may allow content providers to upload content, manage content, receive compensation, and offer other functionality. The content provider may be required to consent to a license, contract, or other provision whereby the content provider agrees that it will only upload content for which the content provider owns and/or controls the distribution rights. FIG. 8 illustrates a process 800 by which a content provider may provide content to the system, such as via a content provider interface. At a block 802 a content provider may manifest a desire to provide content to users via the system, such as by clicking a link or button on a network site provided by the system. Content providers may be required to be registered with the system before they can provide content. Registration may take place through an automated system and/or may require human interaction, such as approval by a system administrator. At a decision block 804 the system determines whether the content provider is registered with the system. If the content provider is not registered, at a block 806 the system may provide the content provider with the opportunity to register with the system. The content provider may be provided with a network site form or another means of registering. The content provider may be required to provide the system with information about the content provider, including contact information, account set up information, and other information. The content provider may also be required to abide by one or more system policies. For example, the content provider may be required to agree that it will not upload copyrighted material, illegal material, or other objectionable material. Once registered, the content provider may be required to log in to the system, such as by providing a username and password.

Once the content provider is registered and/or logged in, at a block 808 the content provider may select content for upload to a server maintained by the system. The content provider may select one or more content files to be uploaded to the system. At a block 810 the content provider may select keywords, categories, and other parameters to be associated with the content to be uploaded. The content provider may be required to enter keywords, categories, and/or other parameters before the content files may be uploaded to the system. At a block 812 the content provider may select from among a plurality of options associated with the content. For example, the content provider may choose to publish its own content and/or share its content with other publishers. At a block 814 the content provider submits its content to the system for approval. For example, the content provider may click a button or link on a system network site page entitled “finalize upload,” “finished,” or another label. At a decision block 816 the system determines whether the content has been approved. Approval may be automated and/or manual, such as by a system administrator. Approval may include verifying file format, completeness, keyword, category, and other information. If the content is approved, at a block 820 the content is uploaded to a server maintained by the system. The system may provide the content provider with a notice indicating that the content was successfully uploaded. If the content is not approved, at a block 818 the content is not uploaded to a system server. The system may provide the content provider with a notice indicating that the content was not approved and/or the content was not successfully uploaded.

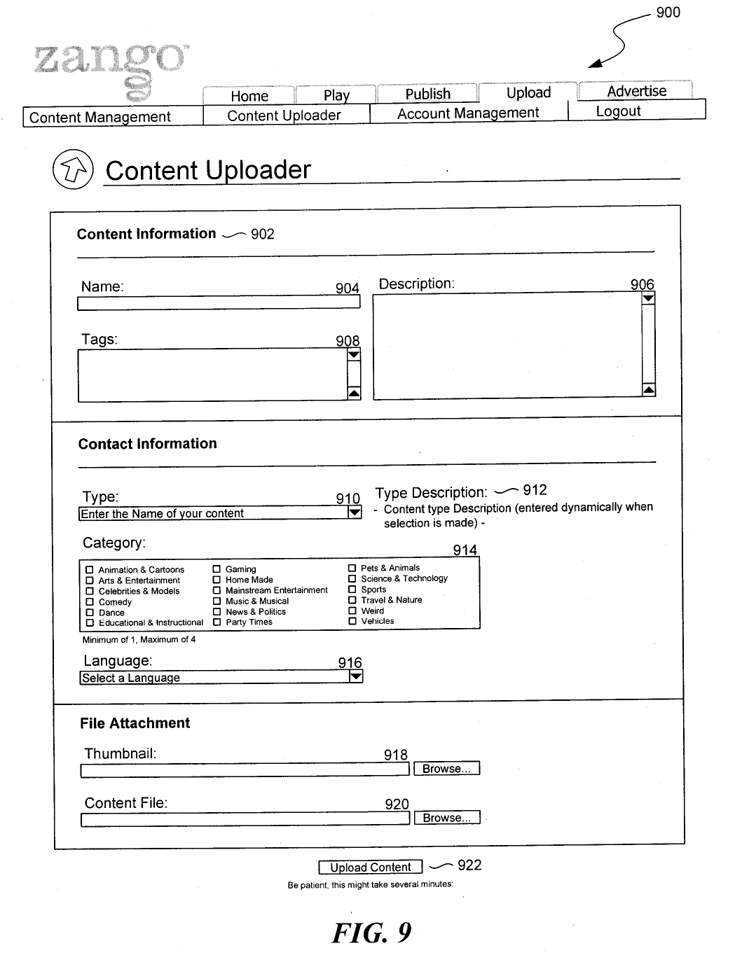

FIG. 9 provides an example of a form 900 that the system may provide to content providers to upload one or more content files to the system. The form may be offered by a network site provided by the system. The content provider may input information 902 about a content file through use of a form 900 or in another manner. The content provider may enter a file name 904, description 906, tags 908, type 910, category 914, language 916, thumbnail 918, content file 920, and other information. Tags 908 may be one or more words or phrases describing the content that may be associated with the file. When a user conducts a search that contains one or more of the tags entered by the content provider, the content files associated with the tags may be returned to the user, such as in the form of a search results list. File type 910 may include audio content, video content, audiovisual content, application, game, screensaver, or other content type. When a type is selected, a type description field 912 may be automatically filled in based on type selected.

The user may also select from among one or more categories 914, including Animation & Cartoons, Arts & Experimental, Celebrities & Models, Comedy, Dance, Educational & Instructional, Gaming, Home Made, Mainstream Entertainment, Music & Musical, News & Politics, Party Times, Pets & Animals, Science & Technology, Sports, Travel & Nature, Weird, Vehicles, Other, and any other categories. The content provider may also select a primary language 916 associated with the content file. The content provider may upload a thumbnail image 918 for the content file. The content provider may select the location 920 from which the file may be uploaded from the content provider's computer system or another location to a system server. The system may set a maximum file size for uploaded files. The content provider may submit the files for upload, such as by clicking a link or button 922 on the site form. One or more of the pieces of information to be entered by the content provider might be required information. That is, the content provider may not be able to upload a content file without providing the required pieces of information. One skilled in the art will appreciate that content files may be uploaded by a content provider in a variety of other ways.

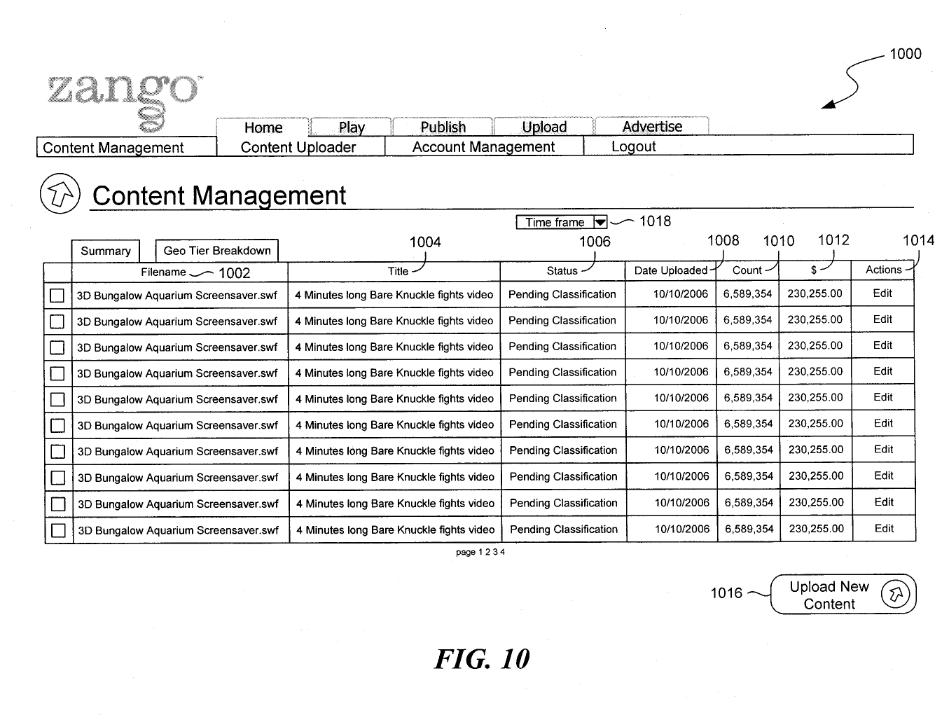

FIG. 10 provides an example of a content provider interface 1000 that may be used by a content provider to manage one or more content files that have been uploaded to the system. The content provider interface may provide information about the content provider's content files, including file name 1002, title 1004, status 1006, date uploaded 1008, count 1010 (e.g., number of times the file has been accessed by users), revenue generated 1012, actions 1014, and other information. Status 1006 may include enabled (or active), disabled (or deactivated), pending classification, and other statuses. An enabled or active file may be a file that has been uploaded and is available to be accessed by a user, such as via a user interface offered by the system or a publisher. A disabled or deactivated file may be a file that has been uploaded to the system but is unavailable to be accessed by a user. A file may be disabled or deactivated for various reasons, such as a question over who owns the copyright to the content, a reported complaint about the content, misclassification of the content, and other reasons. A file may be pending classification if a content provider did not provide a classification, if the system is reviewing a classification made by a content provider, if the file was misclassified, or for other reasons. Actions 1014 may include one or more options regarding an uploaded file, such as edit, delete, deactivate, and other options. The content provider interface may provide the content provider with a selectable menu 1018 from which the content provider may choose a timeframe (e.g., today, yesterday, last week, last month, month to date, etc.) for which the information is to be displayed.

The information about a content provider's files may be provided by the system to the content provider in a table, such as that illustrated in FIG. 10, or in another manner. If the information is presented in a table, the table may be sorted by one or more categories, including title, status, date uploaded, count, revenue generated, or other category. The content provider may be able to select the category or categories by which to sort the table. One or more of the categories, such as count, revenue generated, or other category, may be further delineated by sub-category, such as geographic location. The content provider interface may also provide the content provider with a link or button 1016 to a form, such as that illustrated by FIG. 9, through which the content provider may upload one or more content files. If a content provider has not yet uploaded content or content is not ready for display for one or more reasons, the system may provide a content provider with a notice indicating that no content is available for the content provider's account. One skilled in the art will appreciate that content providers may manage content files in a variety of other ways, including through the use of a variety of other content provider interfaces.

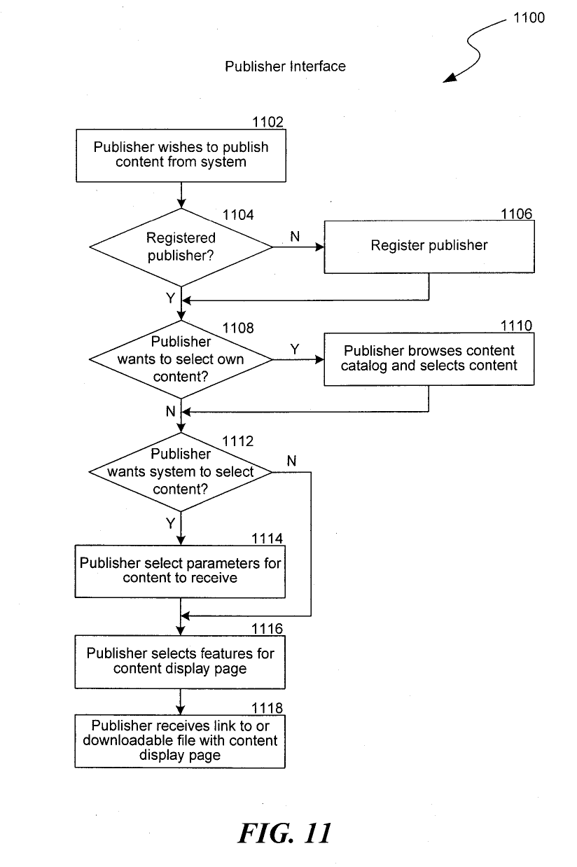

The system may provide an automated, self-service publisher interface that may be used by publishers to access and publish digital content. The publisher interface may allow a publisher to select its own content, choose to have the system select content for the publisher, select parameters for the content to be received, select features for a content display page to be offered by the publisher, and offer other functionality. FIG. 11 illustrates a process 1100 by which a publisher may publish content from the system. At a block 1102 a publisher manifests a desire to publish content from the system, such as by clicking a link or button on a network site provided by the system. The publisher may be required to be registered with the system before the publisher may publish content.

At a decision block 1104 the system determines whether the publisher is registered with the system. If the publisher is not registered, at a block 1106 the system may provide the publisher with the opportunity to register. The publisher may be provided with a network site form or another means of registering. The publisher may be required to provide the system with information about the publisher, including contact information, account set up information, and other information. A publisher may want to self-select the content to be published. Alternatively or additionally, the publisher may want the system to select the content to be published. For example, the system may automatically select the most popular content for the publisher. As the most popular content changes, the system may dynamically update the content that is published by the publisher. The system may dynamically update the content once during a particular time period (e.g., hour, day, week) or in another manner.

At a decision block 1108 the system determines whether the publisher wants to self-select the content to be published. If the publisher wants to select its own content, at a block 1110 the publisher may browse or search a content catalog provided by the system and select the content it wants to publish, or may otherwise select the content it wants to publish. A publisher may sort a content catalog according to one or more categories, including date added, popularity, title, size, language, category, sub-category, or other parameter. At a decision block 1112 the system determines whether the publisher wants the system to select content to be displayed by the publisher, whether instead of or in addition to content self-selected by the publisher. If the publisher wants the system to select content for it, at a block 1114 the publisher may select parameters for the content it is to receive. For example, the publisher may choose to receive content of one or more types, in one or more categories, with one or more terms associated with the content, and/or content defined by other parameters. The publisher may also select the number of content files it wants to receive, the frequency with which the content should be updated (e.g., hourly, daily, weekly, monthly), and other parameters.

At a block 1116 the publisher may select features for one or more content display pages. For example, the publisher may select to receive a link to a content display page that will be hosted by the system, or the publisher may choose to receive a downloadable file from the system that contains a content display page that will be hosted by the publisher. The publisher may also choose whether the content is to be displayed sorted into sections. If the publisher wants the content sorted into sections, the publisher may select how the content should be sorted, such as by category, type, popularity, or other parameter. The publisher may also select whether content images should be displayed, what size content images should be displayed, font style, font size, font color, page color, table properties (e.g., border style, size, color) and other parameters. The system may offer the publisher an option to preview the content display page, such as by clicking a link or button on a system network site page. At a block 1118 the system may deliver to the publisher a link to or a downloadable file that contains the content display page. If a publisher receives a link, the publisher may copy and paste the link onto a network site page offered by the publisher. One skilled in the art will appreciate that content may be provided to the publisher in a variety of other ways.

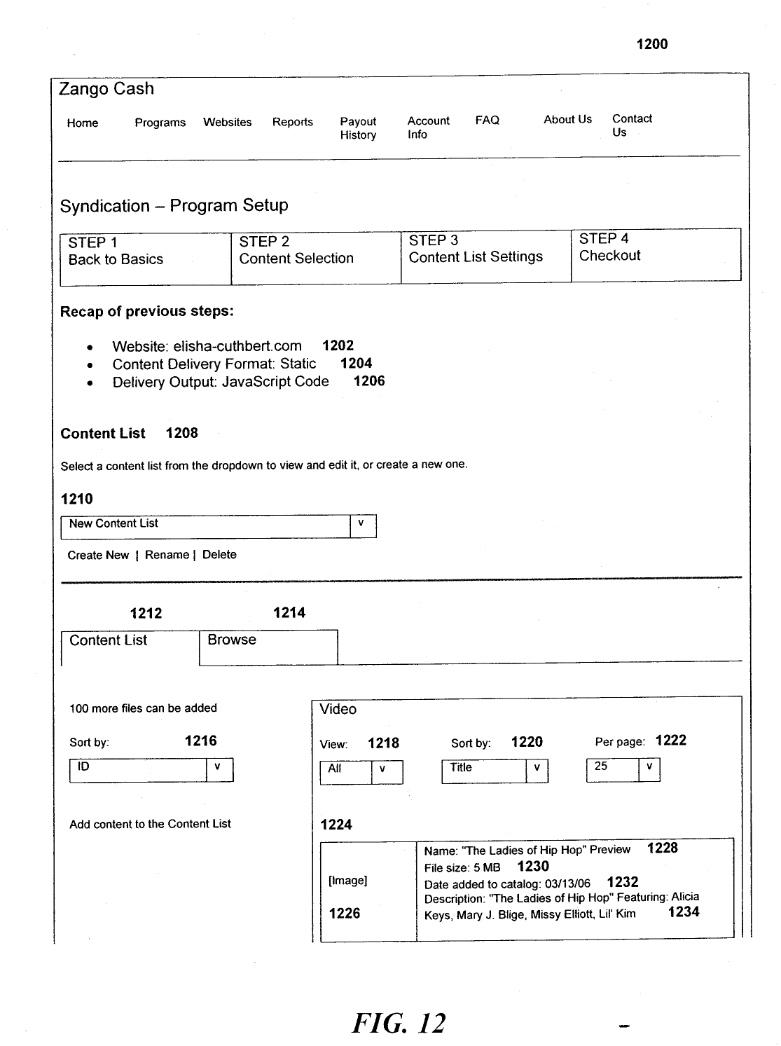

FIG. 12 provides an example of a form 1200 that the system may provide to publishers to allow a publisher to select content to publish. The form may be offered by a network site provided by the system. The form may list information about the publisher, such as the publisher's website 1202, the content delivery format 1204, and the delivery output. As described above, the content delivery format 1204 may be static, dynamic, or another format. As described above, the delivery output method 1206 may be a type of downloadable file, a link to a content display page, or another method. A publisher may select one or more content lists 1208 to which content may be added, such as by selected from a drop down menu 1210. The publisher may view the selected content list 1212 or browse a content catalog 1214, or may select from other options. The publisher may sort files by one or more parameters, such as ID 1216. The publisher may choose which set or subset of files to view 1218, which parameter (e.g., title) to sort by 1220, and how many files to be displayed per page 1222. The system may display information about each content file 1224, such as a thumbnail image 1226, file name 1228, file size 1230, the date the file was added to the catalog 1232, a description of the file 1234, and other information.

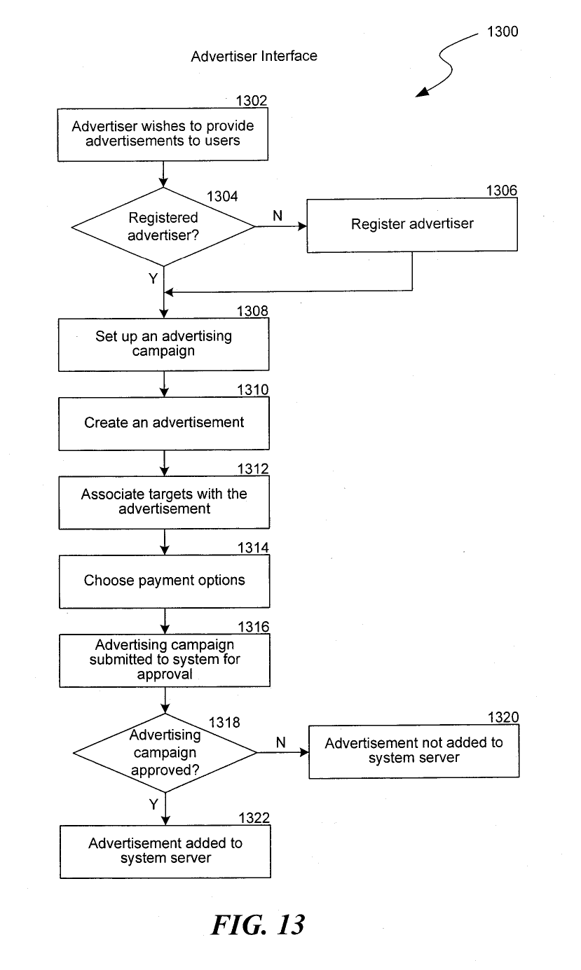

The system may provide an automated, self-service advertiser interface that may be used by advertisers to access and publish digital content. The advertiser interface may allow an advertiser to create advertising campaigns, create and/or upload advertisements, select payment options, and offer other functionality. FIG. 13 illustrates a process 1300 by which an advertiser may provide advertisement data to the system. At a block 1302 an advertiser manifests a desire to provide advertisements to users, via the system, such as by clicking a link or button on a network site provided by the system. An advertiser may be required to be registered with the system before the advertiser can provide advertisements to the system. At a block 1304 the system may determine whether the advertiser is registered with the system. If the advertiser is not registered, at a block 1306 the system may provide the advertiser with the opportunity to register. The advertiser may be provided with a network site form or another means of registering. The advertiser may be required to provide the system with information about the advertiser, including contact information, account set up information, and other information.

Once the advertiser is registered, at a block 1308 the advertiser may set up an advertising campaign. At a block 1310 the advertiser may create or upload an advertisement. As described above, an advertisement may include, but is not limited to, a web address for an advertiser's web site or web page. At a block 1312 the advertiser may associate one or more targets with the advertisement. A target is a word or phrase, URL, or other item that may trigger the system to provide an advertisement associated with the target to a user. For example, a target may be a keyword associated with the advertisement that may be typed as a search query by a user, a URL that may be typed into a browser window by a user, or another item. In some examples, the system may suggest targets to the advertiser. For example, the system may select alternate or additional keywords based on keywords entered by the advertiser. The system may display the estimated user traffic, current bid amount, and other information for the targets entered by the advertiser and/or suggested by the system.

At a block 1314 an advertiser may choose among one or more payment options. For example, the advertiser may be able to choose a method of payment, a payment schedule, and other payment options. An advertiser may deposit money into an account, which the system may withdraw from upon providing advertisements to users. The system may withdraw from the account each time an advertisement is presented, once during a certain time period (e.g., week, month), or by another method. The system may alert an advertiser when the advertiser's balance is low. The advertiser may have the option to receive such alerts from the system, specifying a dollar amount at which to be notified and a frequency with which to be notified.

At a block 1316 the advertiser submits the advertising campaign to the system for approval. At a decision block 1318 the system determines whether the advertising campaign has been approved. If the advertising campaign is approved, at a block 1322 the advertisement and the advertising campaign details are added to a server maintained by the system. The system may provide the advertiser with a notice indicating that the advertisement and the advertising campaign were successfully added to the system. If the advertising campaign is not approved, at a block 1320 the advertisement will not be added to a system server, nor will the details of the advertising campaign be added to a system server. The system may provide the advertiser with a notice indicating that neither the advertisement nor the advertising campaign was added to the system.

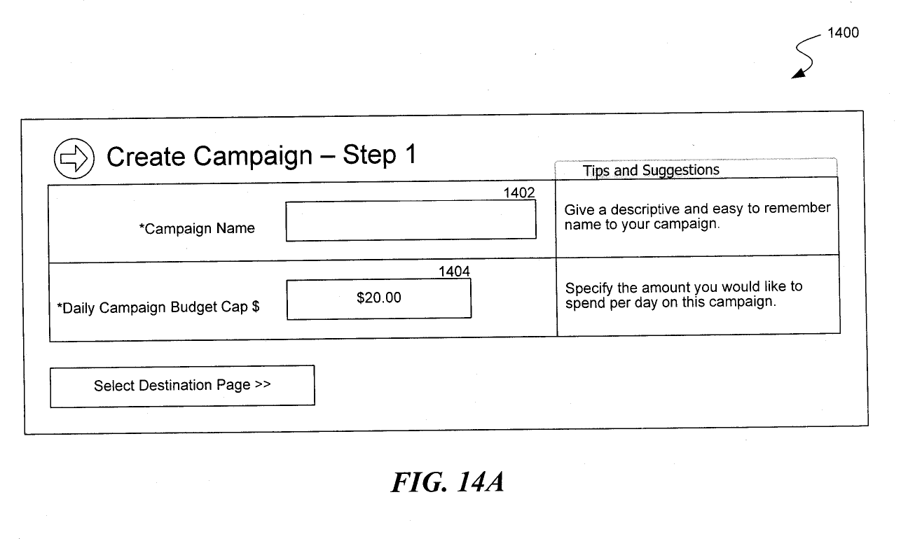

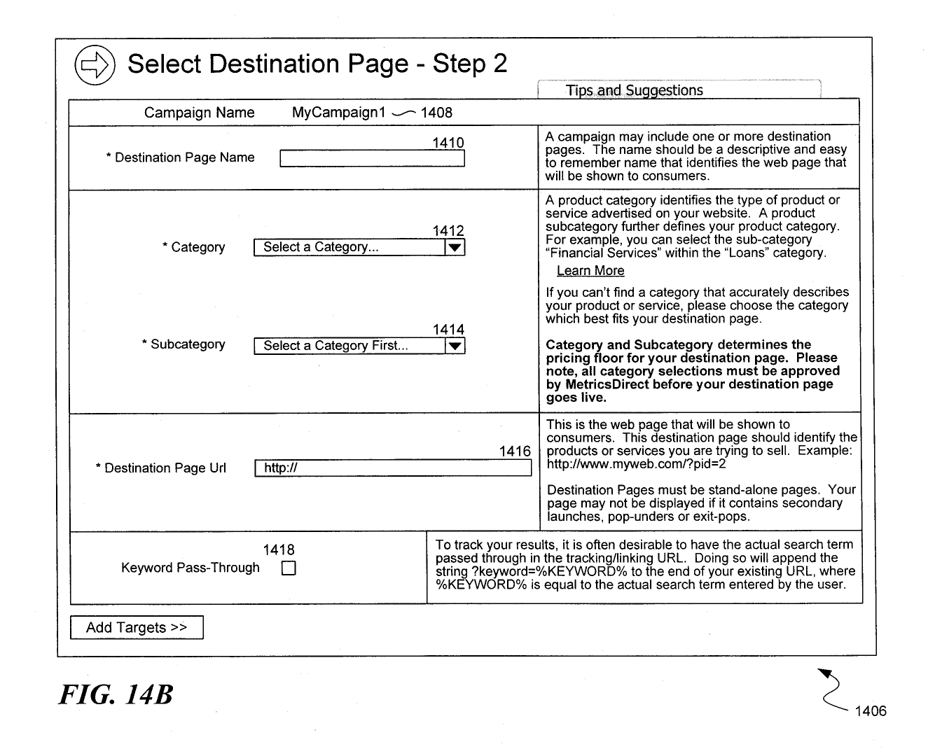

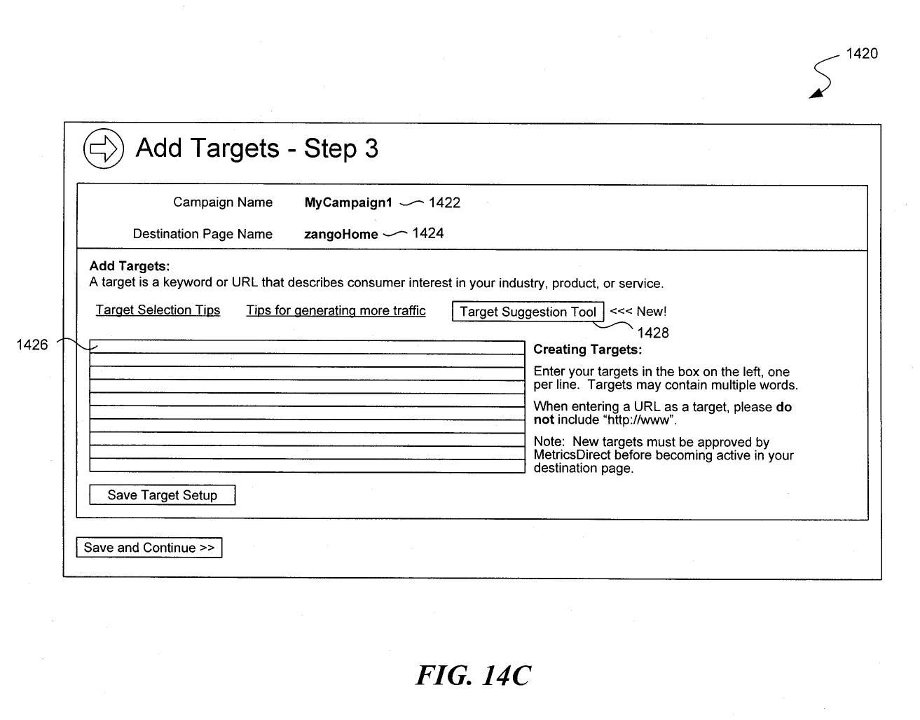

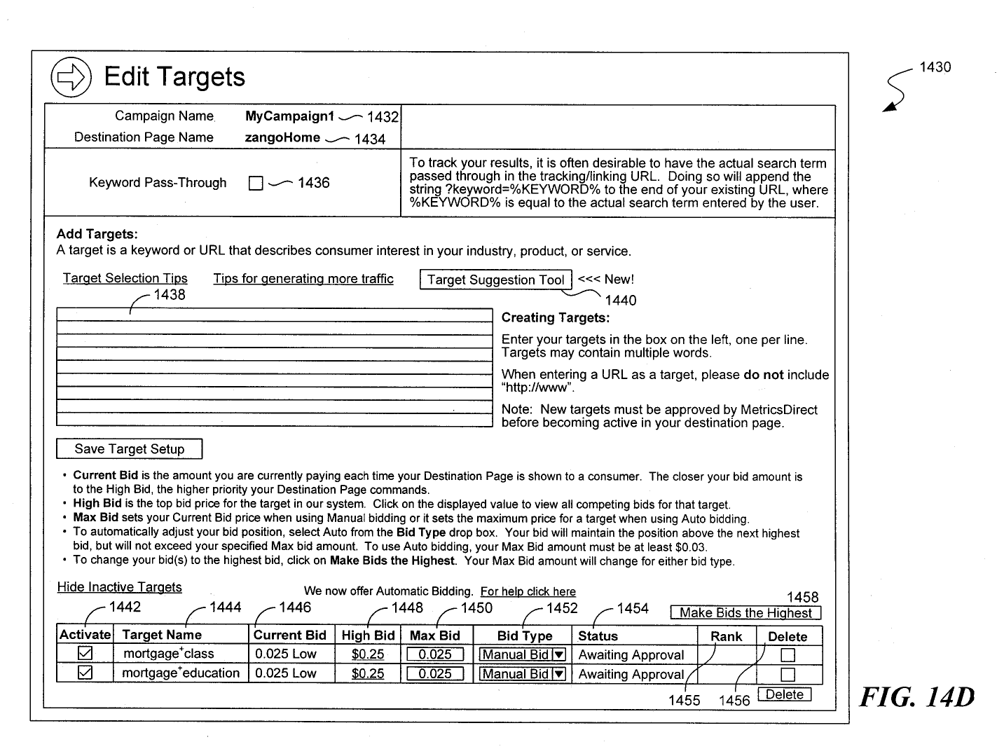

FIGS. 14A-14D provide an example of a series of forms that the system may provide to advertisers to create advertising campaigns. FIG. 14A provides an example of a form 1400 that may be used to create a campaign. An advertiser may enter a campaign name 1402, set a daily campaign budget cap 1404, and other information. A daily campaign budget cap is a maximum amount that the advertiser would like to spend per day on the advertising campaign. The system may notify the advertiser, such as by email, when the cap is hit. The advertiser may also specify how often an individual user may view an advertisement during a given period, such as once per day.

FIG. 14B provides an example of a form 1406 that may be used to select a destination page. A destination page is a network site page that the system will provide to users. The form may include the campaign name 1408 and may prompt the user to enter a name for the destination page 1410, select a product or service category 1412 and/or subcategory 1414, and enter a URL for the destination page 1416. A product or service category identifies the type of product or service offered by the advertiser. A product or service subcategory further defines the product category. The advertiser may also be able to select a keyword pass-through option 1418. If the advertiser selects keyword pass-through, the system will pass the search term entered by a user in the URL. For example, the system may append a string, such as “?keyword=% KEYWORD %” to the end of the destination page URL, where KEYWORD is the keyword entered by the user.

FIG. 14C provides an example of a form 1420 that may be used to add targets to the advertising campaign. The form may display the campaign name 1422 and destination page name 1424 and may provide the advertiser with a field 1426 in which to enter targets. The form may also offer a target suggestion tool 1428.

FIG. 14D provides an example of a form 1430 that may be used to edit targets. The form may include the campaign name 1432 and destination page name 1434 and may again offer the advertiser a keyword pass-through option. The form may provide the advertiser with a field 1438 in which to enter targets and may offer a target suggestion tool 1440. The form may provide information on each keyword, such as whether the keyword is active 1442, the target name 1444, current bid 1446, high bid 1448, maximum bid 1450, bid type 1452, status 1454, rank 1455, and an option to delete the keyword 1456. The current bid 1446 is the amount an advertiser is currently paying each time its destination page is shown to a user. The closer the current bid is to the high bid, the higher priority the system will associate with the advertiser's destination page. The high bid 1448 is the top bid price for the target in the system. The advertiser may be able to click on the displayed high bid value to view all competing bids for the target.

The advertiser may choose from among one or more bid types 1452, such as manual or automatic. The advertiser may change the value in the maximum bid field 1450. If the advertiser has selected manual bidding, changing the value in the maximum bid field will set the current bid 1446. If the advertiser has selected automatic bidding, changing the value in the maximum bid field will set a maximum price. The system will automatically adjust the advertiser's bid position to maintain the position above the next highest bid, but will not exceed the specified maximum bid amount. The status 1454 may include approved, awaiting approval, disapproved, or other statuses. The rank 1455 may list the current rank of the advertiser's bid. The advertiser may be able to click on the displayed rank to view all competing bids for the target. The form may also display the top (e.g., 5) bids, impressions, amount spent, conversions, cost per conversion, and other information.

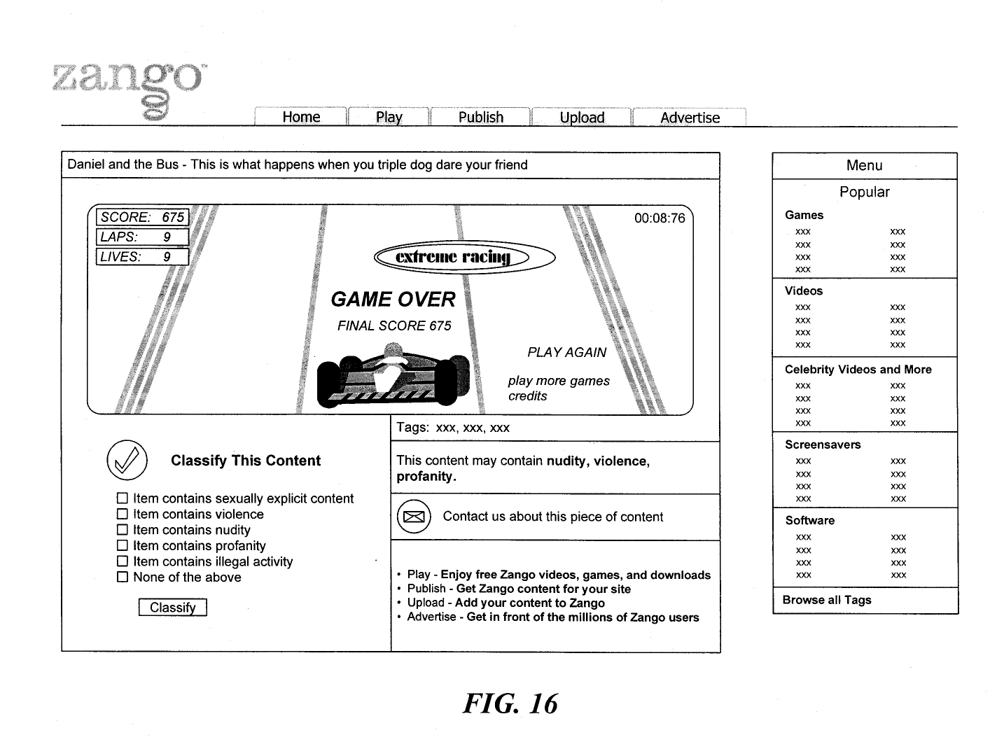

Various alternatives or additions to the above system are possible. For example, the system may allow users to evaluate content. FIG. 16 illustrates a system network site page through which users may evaluate content. Users may evaluate content that has already been classified by the system. Users may also evaluate content that has not yet been classified by the system (i.e., unclassified content). If the user is evaluating unclassified content, the system may provide the user with a notice prior to evaluating content that the content has not yet been classified, such that the system cannot guarantee what the content will contain. The user may be required to agree to a notice provided by the system before the user may evaluate content. The user may choose one or more content files to evaluate. The system may query the user as to whether the file contains violence, profanity, nudity, sexually explicit activity, illegal activity, or other classification. Based on the results received from one or more users, the system may remove objectionable content from the system or move the content to a private catalog. In some examples, the system does not review the content, but will not release content to the public until it has been evaluated and/or rated by one or more system users.

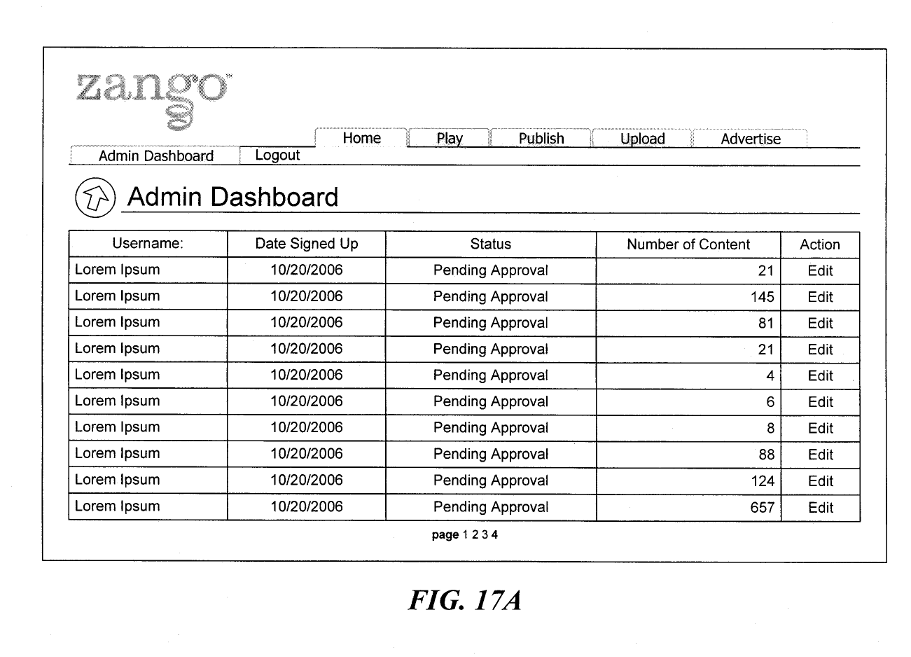

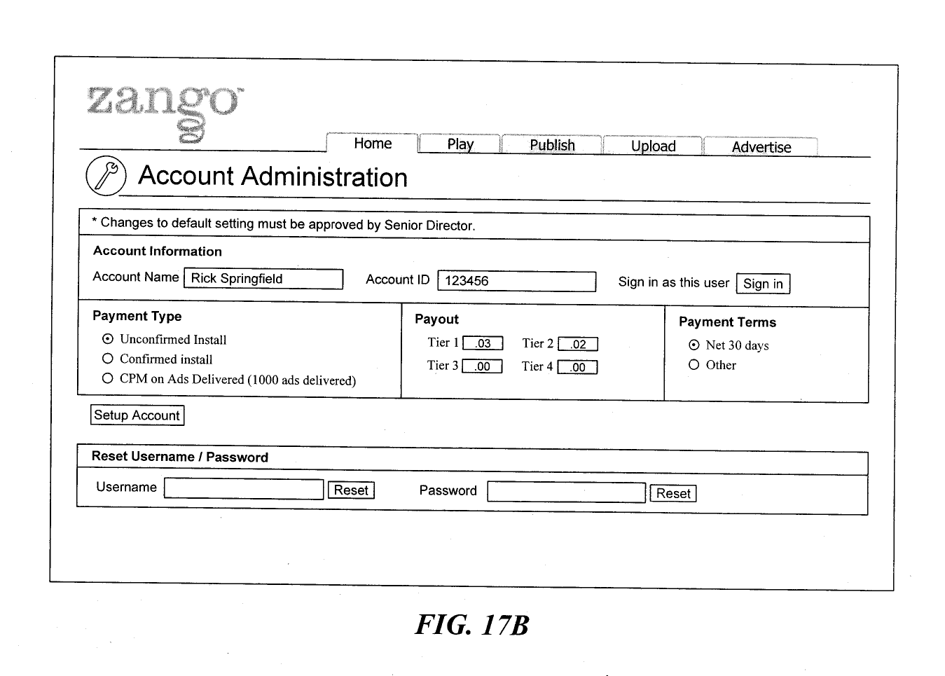

Alternatively or additionally, the system may provide an administrator interface that may be used by one or more system administrators to manage the system. For example, the administrator interface may permit administrators to view the accounts of advertisers, content providers, publishers, and users. FIGS. 17A and 17B illustrate network site pages through which administrators may manage accounts. Administrators may view advertiser, content provider, publisher, and/or user names; date signed up; status; numbers of content or advertisements; actions; and other information. Status may include approved (or enabled), pending approval, not approved (or disabled), and other statuses. Numbers of content or advertisements may include the number of content files or advertisers uploaded by the content provider or advertiser, respectively. It may also include the number of content files published by a publisher or accessed by a user. Actions may include one or more options associated with the content file or advertisement, such as edit, disable, delete, and other options. Administrators may also use the administrator interface to set up or modify the accounts of advertisers, content providers, publishers, and users. For example, an administrator may set up or modify the payment type, amount, terms, and other payment details. An administrator may also use the administrator interface to reset advertiser, content provider, publisher, and user names and passwords.

Alternatively or additionally, users may invite others to join a service offered by the system. For example, users may invite others to join a service by sending messages to others via email, instant message, animated (e.g., flash) greeting card, or other method. Messages may include content files, links to content files, and/or other information.

Alternatively or additionally, the system may offer free products or services for mobile devices (e.g., ring tones, song downloads) in exchange for a user installing a required application on the user's computer system, mobile device, or other compatible system. Advertisements may be displayed to the user via the application, such as in a time-shifted manner described above.

The system may track statistics and offer one or more reports containing those statistics to advertisers, content providers, publishers, and others. For example, the system may track, for each advertisement, the number of times the advertisement was displayed, the targeting criteria that triggered display of the advertisement, the amount paid by the advertiser for display, and other statistics. These statistics may be reported to advertisers. As another example, the system may track, for each content provider, the content files accessed by each user, the number of times each content file was displayed, the revenue generated by each content file, and other statistics. These statistics may be reported to content providers and publishers. The system may also track and report other information, including number of registered users, number of client-side applications installed, revenue generated, and other information.

Music Example

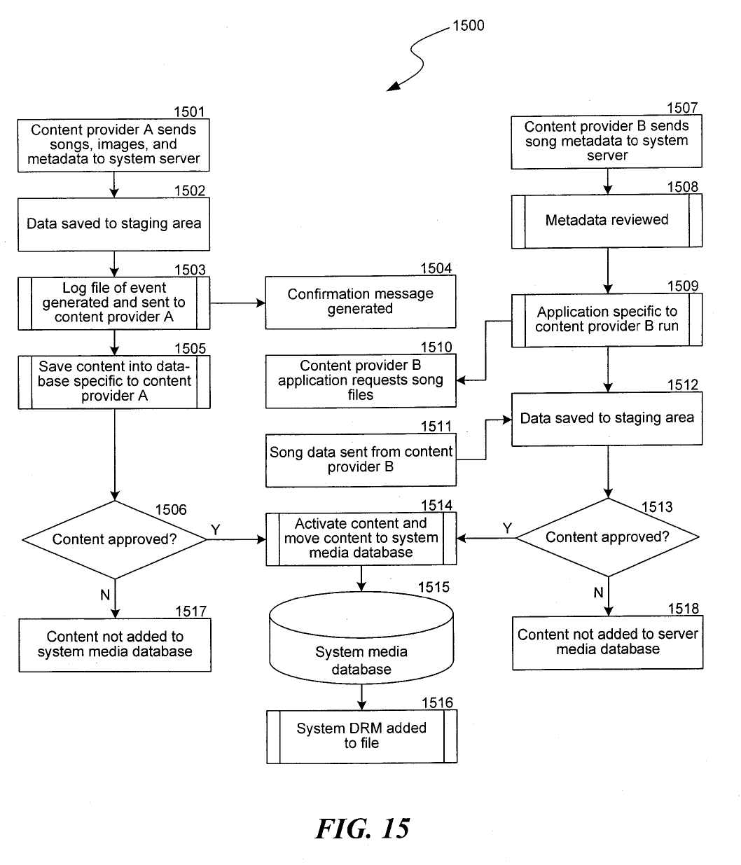

The digital content received and provided by the system may be audio content, video content, audiovisual content, applications, or any other digital content. In one example, the content may be music files. FIG. 15 illustrates an example of a process 1500 by which one or more content providers may provide content and metadata associated with that content to the system. Each content provider may provide content by a different process. At a block 1501 content provider A may send songs, images, and metadata to a system server. At a block 1502 the system may save the data received from content provider A to a staging area. A staging area may be a temporary location that holds content, metadata, and other information before the content, metadata, and other information is added to a media database 1515 maintained by the system. At a block 1503 a log file of the event may be generated and sent to content provider A, and at a block 1504 a confirmation message may be generated. At a block 1505 content may be saved by the system into a database specific to content provider A. Content may include songs, images, metadata, and other content submitted by content provider A. At a decision block 1506 the system may determine whether the content provided by content provider A has been approved for inclusion in a media database 1515 maintained by the system. If the content was approved, at a block 1514 the content may be activated and the system may move the content to the media database 1515. If the content is not approved, at a block 1517 the system may not add the content to the media database.

Another content provider, such as content provider B, may provide content to the system in a different manner. At a block 1507 content provider B may send song metadata to the system server. At a block 1508 the system may review the metadata. At a block 1509 an application specific to content provider B may be run. At a block 1510 the song files may be requested by the content provider B application. At a block 1511 song data may be sent to the system from content provider B, and at a block 1512 the data may be saved by the system to a staging area, such as that described above. At a decision block 1513 the system may determine whether the content provided by content provider B has been approved for inclusion in the media database 1515. If the content has been approved, at block 1514 the content may be activated and the system may move the content to the media database 1515 maintained by the system, as described above. If the content is not approved, at a block 1518 the system may not add the content to the media database. Once content files have been added to the media database 1515, at a block 1516 the system may add its own Digital Rights Management (DRM) information to content files in the media database 1515. For example, system DRM rules may only permit a song to be played if a required application is installed, may limit the number of times a song may be played, may limit the type of device on which a song may be played, and other rules.

In some examples, the system may offer content free of charge for a limited number of plays. For example, a user may be able to listen to a song five times. At the end of the limited number of plays, the user may be presented with the option to purchase one or more content files (e.g., songs), subscribe to one or more services offered by the system, or another option. If the user chooses one of the options, the user may continue to play to the content file. If the user does not choose one of the options, the user's access to the content file may be restricted.

Various alternatives or additions to the system described above are possible. For example, the system may offer free content to users at a reduced bit rate or lower fidelity (e.g., 48 Kbps). The system may offer content to users at a higher bit rate (e.g., 128 Kbps) if a user purchases a content file or subscribes to a service offered by the system.

Alternatively or additionally, the system may only allow users who have purchased content files or subscribed to a service offered by the system to download content files. Those users accessing files for free may be permitted to stream or otherwise access the files, but may not be permitted to download the files.

Alternatively or additionally, the system may restrict the kind of device on which content files may be played. For example, a user who acquires content files for free may only be permitted to play those files on the user's computer system. A user who has purchased content files or subscribed to a service offered by the system may be permitted to play content files on the user's computer system, transfer the files to one or more mobile devices for play, burn the files to a CD, and use the files on other devices.

The system may offer subsets of services to users at different price levels. For example, the system may provide users with limited access to content files, e.g., users may only access files on their computer systems, for a certain fee. For a higher fee, the system may allow users to transfer the files to a mobile device, burn the files to a CD, or use the files in other ways.

Alternatively or additionally, users may be able to create personal profile pages. These profile pages may be hosted by a network site provided by the system. Users may post playlists, personal content libraries, personal information, and other information on their profile pages. Users may be able to search and view the profile pages of other users. In some examples, users may be required to register with the system, have a client-side application installed, or, if the user is already registered, log in to a network site to access the user's own profile page and/or to search or view the profile pages of other users.

Alternatively or additionally, users may be able to save content files to a personal content library. If a user has purchased one or more content files or subscribed to a service offered by the system, the system may permit the user to save one or more content files to the user's personal content library. As long as the user retains rights to the content files or continues to subscribe to a service, the user will be able to access content files from the user's library. If a user has not purchased one or more content files and is not a subscriber (i.e., the user is accessing content files for free), the system may permit the user to save one or more content files to the user's library if the user has a required application installed on the user's computer system. As long as the user keeps the application installed and has free plays of the content files remaining, the user will be able to access content files from the user's library. If a user uninstalls a required application, the user may still be able to view the user's library, but may not be able to access the files (e.g., play music) in the library. The system may display information to the user about the files in the user's library, including artist, title, and other information. In some examples, a user's library may be displayed on the user's profile page. Users may search the libraries of other users. For example, a user may want to know what is in his friends' libraries, or a user may want to search the libraries of other users who have similar content files in their libraries.

Users may create, share, and download one or more content playlists. A playlist is a list of content files created by a user, a content provider, or by the system. Playlists may group content by characteristic, genre, or other feature, or they may be a random grouping, user-selected, content provider-selected, or system-selected grouping of content files. Users may be permitted to create playlists if they subscribe to a service offered by the system. Users may also be permitted to create playlists of content files they have rights to, e.g., have purchased. Users may also be permitted to create playlists if they have a required application installed on their computer systems, as noted above. One skilled in the art will appreciate that playlists may be created in other ways.

In some examples, users may share one or more playlists with other users via email, instant message, animated (e.g., flash) greeting card, or other method. In some examples, users may share playlists if they subscribe to a service offered by the system or if they have a required application installed on their computer systems.

In some examples, users may download one or more songs or playlists via an email message, an instant message, a network site provided by the system, an animated (e.g., flash) greeting card, another user's profile, or in another manner. In some examples, a user may receive an email with a link to a song or playlist. The user may be required to register with or, if already registered, log in to the network site. The user may be permitted to download the song or playlist if the user is a subscriber to a service offered by the system. Alternatively or additionally, the user may be permitted to download the song or playlist, free of charge, if the user has a required application installed on the user's computer system.

Again, many alternatives or additions are possible. For example, a user may download one or more songs or playlists from another user's profile. Each user may display one or more songs or playlists on a profile page. Users may be required to register with or, if already registered, log in to the network site in order to view other users profile pages, including other users' songs and playlists. A user may click on another's user's song or playlist to download the song or playlist. A user may be permitted to download the song or playlist if the user is a subscriber to a service offered by the system. The user may also be permitted to download the song or playlist, free of charge, if the user has a required application installed on the user's computer system.

Alternatively or additionally, users may invite others to join a service offered by the system. Users may invite others to join a service by sending individual content files, playlists, or both, to others via email, instant message, animated (e.g., flash) greeting card, or other method.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various examples described herein can be combined to provide further examples.

Any patents, applications, and other references, including any that may be listed in accompanying filing papers, are incorporated herein by reference. Aspects of the invention can be modified, if necessary, to employ the systems, functions, and concepts of the various references described above to provide yet further examples of the invention.

These and other changes can be made to the invention in light of the above Detailed Description. While the above description details certain examples of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention.

While certain aspects of the invention are presented below in certain claim forms, the inventors contemplate the various aspects of the invention in any number of claim forms. For example, while only one aspect of the invention is recited as a means-plus-function claim under 35 U.S.C sec. 112, sixth paragraph, other aspects may likewise be embodied as a means-plus-function claim. (Any claims intended to be treated under 35 U.S.C. §112, ¶6 will begin with the words “means for”.) Accordingly, the inventors reserve the right to add additional claims after filing the application to pursue such additional claim forms for other aspects of the invention.

I/We claim:

1. A system for providing digital content and advertisements to users, the system comprising:
an automated, self-service advertiser interface for advertisers, wherein the advertiser interface is used by the advertisers to provide digital advertisements, and wherein the advertisers provide compensation based on presenting the digital advertisements to the users;
an automated, self-service content-provider interface for providers of digital content, wherein the content-provider interface is used by the providers of digital content to provide content to the users, wherein the digital content is visual content, audio content, audio-visual content, or an application, and wherein the providers of digital content receive a first portion of the advertiser-provided compensation based on access of the digital content by the users;
a publisher interface for publishers of the digital content, wherein the publisher interface is configured to provide the publishers with access to the digital content or to links for accessing the digital content, wherein the publisher provides at least one user interface for the users to access the content, and wherein the publishers receive a second portion of the advertiser-provided compensation based on access of the provided digital content by the users;
an automated, self-service user interface for the users of the digital content, wherein the user interface is configured to provide users with access to view or listen to the digital content; and,
at least one central server coupled among the advertiser, content-provider, publisher, and user interfaces, wherein the central server is configured to:
store or access the digital content and the advertisements,
provide the digital content and the advertisements to the users,
receive the advertiser-provided compensation from the advertisers, and
provide the first and second portions of the advertiser-provided compensation to the publishers and the content providers, respectively.

2. The system of claim 1 wherein the advertiser interface is configured to permit each of the advertisers to specify at least one category for each of its digital advertisements and at least one target associated with each of its digital advertisements.

3. The system of claim 1 wherein the content-provider interface is configured to permit each of the content-providers to specify one or more categories associated with each of its digital content files.

4. The system of claim 1 wherein the publisher interface is configured to allow publishers to browse or search for digital content.

5. The system of claim 1 wherein the digital advertisements are time-shifted, wherein the time shifting includes providing one or more of the digital advertisements to at least one of the users when the user conducts an Internet-based search.

6. The system of claim 1 wherein the advertiser interface is configured to permit each of the advertisers to set a bid amount for each of its digital advertisements, wherein the bid amount is an amount of compensation the advertiser is willing to provide for presentation of its digital advertisement to a user.

7. The system of claim 1 wherein the digital content is provided free to users in exchange for viewing the digital advertisements.

8. The system of claim 1 wherein the server computer provides a client-side application to user computers for viewing or listening to the digital content and for viewing the advertisements.

9. The system of claim 1 wherein the advertiser interface is configured to permit each of the advertisers to choose the content with which its advertisements will be associated, including choosing the content with which its advertisements will not be associated.

10. The system of claim 1 wherein a subset of available content is automatically selected for display by a publisher.

11. A method for providing digital content and advertisements to a client computer system via a client-side application for providing access to the digital content and to the advertisements, the method comprising:
receiving a request from the client computer system to access digital content;
determining whether the client computer system has the client-side application for displaying the digital content and the advertisements installed;
if the client computer system does not have the client-side application installed, providing instructions for installing the client-side application in exchange for providing access to the requested digital content;
if the client computer system does have the client-side application installed, providing access to the requested digital content; and
providing digital advertisements to the client computer system after providing the requested digital content.

12. The method of claim 11 wherein digital content previously accessible by the client computer system will no longer be accessible by the client computer system if the client-side application is uninstalled.

13. The method of claim 11 wherein providing the digital advertisements includes providing one or more of the digital advertisements when a user conducts an Internet-based search.

14. The method of claim 11 wherein the digital content includes a digital rights management portion that prohibits or inhibits the client computer from playing the digital content unless the client-side application is installed on the client computer.

15. A computer-readable medium carrying instructions for a method to permit a publisher to readily provide digital content and advertisements to multiple, geographically distributed client computers via a public computer network, the method comprising:
providing a search interface for permitting the publisher to search a database of digital content to identify desired digital content;
providing access to the desired digital content or to links for accessing the desired digital content;
wherein the publisher provides at least one user interface for accessing the desired digital content;
wherein the publisher automatically receives a portion of advertiser-provided compensation based on access to the desired digital content, or based on requests to access the desired digital content, by the multiple, geographically distributed client computers; and,
wherein digital advertisements associated with the advertiser-provided compensation are provided to the multiple, geographically distributed client computers after receiving access to at least some of the desired digital content.

16. The computer-readable medium of claim 15 wherein each of the client computers include a client-side application for providing access to the digital content and to the digital advertisements.

17. The computer-readable medium of claim 15, further comprising automatically providing digital content to the publisher, wherein the automatically provided digital content includes currently determined popular digital content.

18. A system for receiving digital content and advertisements, the system comprising:
means for accessing selected digital content from a set of available digital content, wherein the set of available digital content is provided at a publisher website, and wherein the set of available digital content is provided or generated by multiple, different digital content providers;
means for viewing or listening to more than a sampling of the selected digital content, for free, if at least one predetermined criterion is satisfied; and,
means for providing at least one time-shifted digital advertisement associated with an advertiser website,
wherein the publisher and at least one content provider each automatically receive a portion of advertiser-provided compensation based on the providing of the at least one time-shifted digital advertisement associated with the advertiser website.

19. The system of claim 18 wherein the predetermined criterion is whether the means for providing at least one time-shifted digital advertisement is installed at a client-side computer that is to receive the selected digital content.

20. The system of claim 18 wherein the means for providing at least one time-shifted digital advertisement includes means for launching a browser and displaying a web page associated with the advertiser website, wherein the web page is contextually associated with a user-based internet search.
